(19) United States
(12) Patent Application Publication
(10) Pub. No.: US 2005/0164744 A1
(43) Pub. Date: Jul. 28, 2005

(54) Apparatus and method operable in a wireless local area network incorporating tunable dielectric capacitors embodied within an inteligent adaptive antenna

(76) Inventor: Nicolaas D du Toit, Columbia, MD (US)

Correspondence Address: James S. Finn;c/o Bill Tucker, 14431 Goliad Dr., Box #8, Malakoff, TX, 75148, US

(21) Appl. No.: 11/045,909

(22) Filed: Jan. 28, 2005

Related U.S. Application Data
(60) Provisional application No. 60/539,692, filed on Jan. 28, 2004.

(51) Int. Cl. H04B 1/38

(52) U.S. Cl. 455/562.1; 455/561

(57) ABSTRACT

An embodiment of the present invention provides an apparatus, comprising a software controllable phased-array antenna with voltage tunable dielectric materials embodied therein enabling the concentration of RF energy from a transmitting wireless station (STA) into the direction of a receiving STA. An embodiment of the present invention my further comprise controlling software embodied within a Medium Access Control layer (MAC) of a Wireless Local Area Network (WLAN) system with which the apparatus is a part of, wherein the controlling software may control the concentration of RF energy from a transmitting STA into the direction of a receiving STA, thereby allowing higher data rates and higher data throughput to be achieved by the WLAN system.

### CROSS-REFERENCE TO RELATED APPLICATION

This application claims the benefit of priority under 35 U.S.C Section 119 from U.S. Provisional Application Ser. No. 60/539,692, filed Jan. 28, 2004, entitled “WIRELESS LAN INCORPORATING PARASCAN™ TUNABLE CAPACITORS EMBODIED WITHIN AN INTELIGENT ADAPTIVE ANTENNA” by Nicolaas D du Toit.

### BACKGROUND OF THE INVENTION

Wireless local area networks (WLAN) have become prevalent throughout society and improvements for wireless communication techniques are always sought after. Inherent and vital to a wireless local area network is the Physical Layer (PHY). The physical layers used in a wireless local area networks (which may also be referred to herein as Institute for Electronic and Electrical Engineers (IEEE) 802.11) are fundamentally different from wired media. WLAN PHYs:
a) Use a medium that has neither absolute nor readily observable boundaries outside of which stations with conformant PHY transceivers are known to be unable to receive network frames.
b) Are unprotected from outside signals.
c) Communicate over a medium significantly less reliable than wired PHYs.
d) Have dynamic topologies.
e) Lack full connectivity, and therefore the assumption normally made that every wireless station (STA) can hear every other STA is invalid (i.e., STAs may be “hidden” from each other).
f) Have time-varying and asymmetric propagation properties.

Therefore, there is a constant need for techniques that improve the PHY and therefore WLANs in general.

### SUMMARY OF THE INVENTION

An embodiment of the present invention provides an apparatus, comprising a software controllable phased-array antenna with voltage tunable dielectric materials embodied therein enabling the concentration of RF energy from a transmitting wireless station (STA) into the direction of a receiving STA. An embodiment of the present invention may further comprise controlling software embodied within a Medium Access Control layer (MAC) of a Wireless Local Area Network (WLAN) system with which the apparatus is a part of, wherein the controlling software may control the concentration of RF energy from a transmitting STA into the direction of a receiving STA, thereby allowing higher data rates and higher data throughput to be achieved by the WLAN system.

The antenna may transmit sufficient RF energy in the direction of all other STAs in the service area in addition to the receiving STA, thereby preventing collisions by making them aware of ongoing transmissions. The MAC may be assumed to be the master and the phased-array antenna may be assumed to be a slave and all modes may be initiated and terminated by the MAC. In an embodiment of the present invention, the phased-array antenna may have a controller capable of managing all antenna hardware and the hardware may comprise passive tunable phase shifters and antenna elements. The phased-array antenna may have omni-directional and directional modes and may be capable of settling to a new beam direction in less than 10 μs is and be capable of operating in a learning mode, an omni mode, a fixed direction mode and/or an adaptive directional mode. In another embodiment of the present invention the apparatus is capable of operating in a Mesh network and the highest possible data rate may be maintained by invoking the Fixed Directional Mode or Adaptive Directional Mode, when necessary.

In yet another embodiment of the present invention is provided a method of concentrating RF energy from a transmitting wireless station (STA) into the direction of a receiving STA in a wireless local area network (WLAN), comprising controlling a phased-array antenna by using voltage tunable dielectric materials embodied in the phase array antenna to concentrate the RF energy from the transmitting wireless station (STA) into the direction of the receiving STA in the wireless local area network (WLAN). This method may further comprise using software embodied within a Medium Access Control layer (MAC) of a Wireless Local Area Network (WLAN) system with which the apparatus is a part of to control the phased-array antenna.

### BRIEF DESCRIPTION OF THE DRAWINGS

The present invention is described with reference to the accompanying drawings. In the drawings, like reference numbers indicate identical or functionally similar elements. Additionally, the left-most digit(s) of a reference number identifies the drawing in which the reference number first appears.

FIG. 1 illustrates an example of one embodiment of the present invention of a WLAN geometry depicting an access point (AP) communicating with a Station S1 while keeping the NAV of a potentially interfering Station S2 updated.

### DESCRIPTION OF THE PREFERRED EMBODIMENT

An embodiment of the present invention represents a significant step towards making the WLAN medium more reliable and predictable and ultimately ensuring optimal data throughput between wireless stations (STAs). “STA” refers to a station, i.e. any addressable unit within the WLAN, not necessarily of fixed location, but nevertheless a termination point for a message. Important to the present invention is the Parascan® family of voltage tunable dielectric materials with superior electronic properties.

Parascan® is a family of tunable dielectric material with excellent RF and microwave properties, such as, high Q, fast tuning, and high IP3. Further, the term Parascan® as used herein is a trademarked word indicating a tunable dielectric material developed by the assignee of the present invention. Parascan® tunable dielectric materials have been described in several patents. Barium strontium titanate (BaTiO₃—SrTiO₃), also referred to as BSTO, is used for its high dielectric constant (200-6,000) and large change in dielectric constant with applied voltage (25-75 percent with a field of 2 Volts/micron). Tunable dielectric materials including barium strontium titanate are disclosed in U.S. Pat. No. 5,312,790 to Sengupta, et al. entitled “Ceramic Ferroelectric Material”; U.S. Pat. No. 5,427,988 by Sengupta, et al. entitled “Ceramic Ferroelectric Composite Material-BSTO-MgO”; U.S. Pat. No. 5,486,491 to Sengupta, et al. entitled “Ceramic Ferroelectric Composite Material—BSTO-ZrO₂”; U.S. Pat. No. 5,635,434 by Sengupta, et al. entitled “Ceramic Ferroelectric Composite Material-BSTO-Magnesium Based Compound”; U.S. Pat. No. 5,830,591 by Sengupta, et al. entitled “Multilayered Ferroelectric Composite Waveguides”; U.S. Pat. No. 5,846,893 by Sengupta, et al. entitled “Thin Film Ferroelectric Composites and Method of Making”; U.S. Pat. No. 5,766,697 by Sengupta, et al. entitled “Method of Making Thin Film Composites”; U.S. Pat. No. 5,693,429 by Sengupta, et al. entitled “Electronically Graded Multilayer Ferroelectric Composites”; U.S. Pat. No. 5,635,433 by Sengupta entitled “Ceramic Ferroelectric Composite Material BSTO-ZnO”; U.S. Pat. No. 6,074,971 by Chiu et al. entitled “Ceramic Ferroelectric Composite Materials with Enhanced Electronic Properties BSTO-Mg Based Compound-Rare Earth Oxide”. These patents are incorporated herein by reference. The materials shown in these patents, especially BSTO-MgO composites, show low dielectric loss and high tunability. Tunability is defined as the fractional change in the dielectric constant with applied voltage.

Barium strontium titanate of the formula BaₓSr₁₋ₓ,TiO₃ is a preferred electronically tunable dielectric material due to its favorable tuning characteristics, low Curie temperatures and low microwave loss properties. In the formula BaₓSr₁₋ₓ,TiO₃, x can be any value from 0 to 1, preferably from about 0.15 to about 0.6. More preferably, x is from 0.3 to 0.6.

Other electronically tunable dielectric materials may be used partially or entirely in place of barium strontium titanate. An example is BaₓCa₁₋ₓ,TiO₃, where x is in a range from about 0.2 to about 0.8, preferably from about 0.4 to about 0.6. Additional electronically tunable ferroelectrics include PbₓZr₁₋ₓTiO₃ (PZT) where x ranges from about 0.0 to about 1.0, PbₓZr₁₋ₓSrTiO₃ where x ranges from about 0.05 to about 0.4, KTaₓNb₁₋ₓO₃ where x ranges from about 0.0 to about 1.0, lead lanthanum zirconium titanate (PLZT), PbTiO₃, BaCaZrTiO₃, NaNO₃, KNbO₃, LiNbO₃, LiTaO₃, PbNb₂O₆, PbTa₂O₆, KSr(NbO₃) and NaBa₂(NbO₃)₅KH₂PO₄, and mixtures and compositions thereof. Also, these materials can be combined with low loss dielectric materials, such as magnesium oxide (MgO), aluminum oxide (Al₂O₃), and zirconium oxide (ZrO₂), and/or with additional doping elements, such as manganese (MN), iron (Fe), and tungsten (W), or with other alkali earth metal oxides (i.e. calcium oxide, etc.), transition metal oxides, silicates, niobates, tantalates, aluminates, zirconnates, and titanates to further reduce the dielectric loss.

In addition, the following U.S. patent applications, assigned to the assignee of this application, disclose additional examples of tunable dielectric materials: U.S. application Ser. No. 09/594,837 filed Jun. 15, 2000, entitled “Electronically Tunable Ceramic Materials Including Tunable Dielectric and Metal Silicate Phases”; U.S. application Ser. No. 09/768,690 filed Jan. 24, 2001, entitled “Electronically Tunable, Low-Loss Ceramic Materials Including a Tunable Dielectric Phase and Multiple Metal Oxide Phases”; U.S. application Ser. No. 09/882,605 filed Jun. 15, 2001, entitled “Electronically Tunable Dielectric Composite Thick Films And Methods Of Making Same”; U.S. application Ser. No. 09/834,327 filed Apr. 13, 2001, entitled “Strain-Relieved Tunable Dielectric Thin Films”; and U.S. Provisional Application Ser. No. 60/295,046 filed Jun. 1, 2001 entitled “Tunable Dielectric Compositions Including Low Loss Glass Frits”. These patent applications are incorporated herein by reference.

The tunable dielectric materials can also be combined with one or more non-tunable dielectric materials. The non-tunable phase(s) may include MgO, MgAl₂O₄, MgTiO₃, Mg₂SiO₄, CaSiO₃, MgSrZrTiO₆, CaTiO₃, Al₂O₃, SiO₂ and/or other metal silicates such as BaSiO₃ and SrSiO₃. The non-tunable dielectric phases may be any combination of the above, e.g., MgO combined with MgTiO₃, MgO combined with MgSrZrTiO₆, MgO combined with Mg₂SiO₄, MgO combined with Mg₂SiO₄, Mg₂SiO₄ combined with CaTiO₃ and the like.

Additional minor additives in amounts of from about 0.1 to about 5 weight percent can be added to the composites to additionally improve the electronic properties of the films. These minor additives include oxides such as zirconnates, tannates, rare earths, niobates and tantalates. For example, the minor additives may include CaZrO₃, BaZrO₃, SrZrO₃, BaSnO₃, CaSnO₃, MgSnO₃, Bi₂O₃/2SnO₂, Nd₂O₃, Pr₇O₁₁, Yb₂O₃, Ho₂O₃, La₂O₃, MgNb₂O₆, SrNb₂O₆, BaNb₂O₆, MgTa₂O₆, BaTa₂O₆ and Ta₂O₃.

Thick films of tunable dielectric composites can comprise Ba₁₋ₓSrₓTiO₃, where x is from 0.3 to 0.7 in combination with at least one non-tunable dielectric phase selected from MgO, MgTiO₃, MgZrO₃, MgSrZrTiO₆, Mg₂SiO₄, CaSiO₃, MgAl₂O₄, CaTiO₃, Al₂O₃, SiO₂, BaSiO₃ and SrSiO₃. These compositions can be BSTO and one of these components, or two or more of these components in quantities from 0.25 weight percent to 80 weight percent with BSTO weight ratios of 99.75 weight percent to 20 weight percent.

The electronically tunable materials can also include at least one metal silicate phase. The metal silicates may include metals from Group 2A of the Periodic Table, i.e., Be, Mg, Ca, Sr, Ba and Ra, preferably Mg, Ca, Sr and Ba. Preferred metal silicates include Mg₂SiO₄, CaSiO₃, BaSiO₃ and SrSiO₃. In addition to Group 2A metals, the present metal silicates may include metals from Group 1A, i.e., Li, Na, K, Rb, Cs and Fr, preferably Li, Na and K. For example, such metal silicates may include sodium silicates such as Na₂SiO₃ and NaSiO₃-5H₂O, and lithium-containing silicates such as LiAlSiO₄, Li₂SiO₃ and Li₄SiO₄. Metals from Groups 3A, 4A and some transition metals of the Periodic Table may also be suitable constituents of the metal silicate phase. Additional metal silicates may include Al₂Si₂O₇, ZrSiO₄, KalSi₃O₈, NaAlSi₃O₈, CaAl₂Si₂O₈, CaMgSi₂O₆, BaTiSi₃O₉ and Zn₂SiO₄. The above tunable materials can be tuned at room temperature by controlling an electric field that is applied across the materials.

In addition to the electronically tunable dielectric phase, the electronically tunable materials can include at least two additional metal oxide phases. The additional metal oxides may include metals from Group 2A of the Periodic Table, i.e., Mg, Ca, Sr, Ba, Be and Ra, preferably Mg, Ca, Sr and Ba. The additional metal oxides may also include metals from Group 1A, i.e., Li, Na, K, Rb, Cs and Fr, preferably Li, Na and K. Metals from other Groups of the Periodic Table may also be suitable constituents of the metal oxide phases. For example, refractory metals such as Ti, V, Cr, Mn, Zr, Nb, Mo, Hf, Ta and W may be used. Furthermore, metals such as Al, Si, Sn, Pb and Bi may be used. In addition, the metal oxide phases may comprise rare earth metals such as Sc, Y, La, Ce, Pr, Nd and the like.

The additional metal oxides may include, for example, zirconnates, silicates, titanates, aluminates, stannates, niobates, tantalates and rare earth oxides. Preferred additional metal oxides include Mg₂SiO₄, MgO, CaTiO₃, MgZrSrTiO₆, MgTiO₃, MgAl₂O₄, WO₃, SnTiO₄, ZrTiO₄, CaSiO₃, CaSnO₃, CaWO₄, CaZrO₃, MgTa₂O₆, MgZrO₃, MnO₂, PbO, Bi₂O₃ and La₂O₃. Particularly preferred additional metal oxides include Mg₂SiO₄, MgO, CaTiO₃, MgzrSrTiO₆, MgTiO₃, MgAl₂O₄, MgTa₂O₆ and MgZrO₃.

The additional metal oxide phases are typically present in total amounts of from about 1 to about 80 weight percent of the material, preferably from about 3 to about 65 weight percent, and more preferably from about 5 to about 60 weight percent. In one preferred embodiment, the additional metal oxides comprise from about 10 to about 50 total weight percent of the material. The individual amount of each additional metal oxide may be adjusted to provide the desired properties. Where two additional metal oxides are used, their weight ratios may vary, for example, from about 1:100 to about 100:1, typically from about 1:10 to about 10:1 or from about 1:5 to about 5:1. Although metal oxides in total amounts of from 1 to 80 weight percent are typically used, smaller additive amounts of from 0.01 to 1 weight percent may be used for some applications.

The additional metal oxide phases can include at least two Mg-containing compounds. In addition to the multiple Mg-containing compounds, the material may optionally include Mg-free compounds, for example, oxides of metals selected from Si, Ca, Zr, Ti, Al and/or rare earths.

Parascan® voltage tunable dielectric materials may be embodied within a software controllable phased-array antenna, herein referred to as the Adaptive Antenna System. The controlling software may be embodied within the Medium Access Control layer (MAC) of the WLAN system of this invention.

The Adaptive Antenna System, while being properly controlled by the MAC, concentrates RF energy from a transmitting STA into the direction of a receiving STA, thereby allowing higher data rates and hence higher data throughput to be achieved by the WLAN system of one embodiment of the present invention. At the same time, sufficient RF energy may still be beamed in the direction of all other STAs in the service area, making them aware of the ongoing transmission, thus preventing collisions.

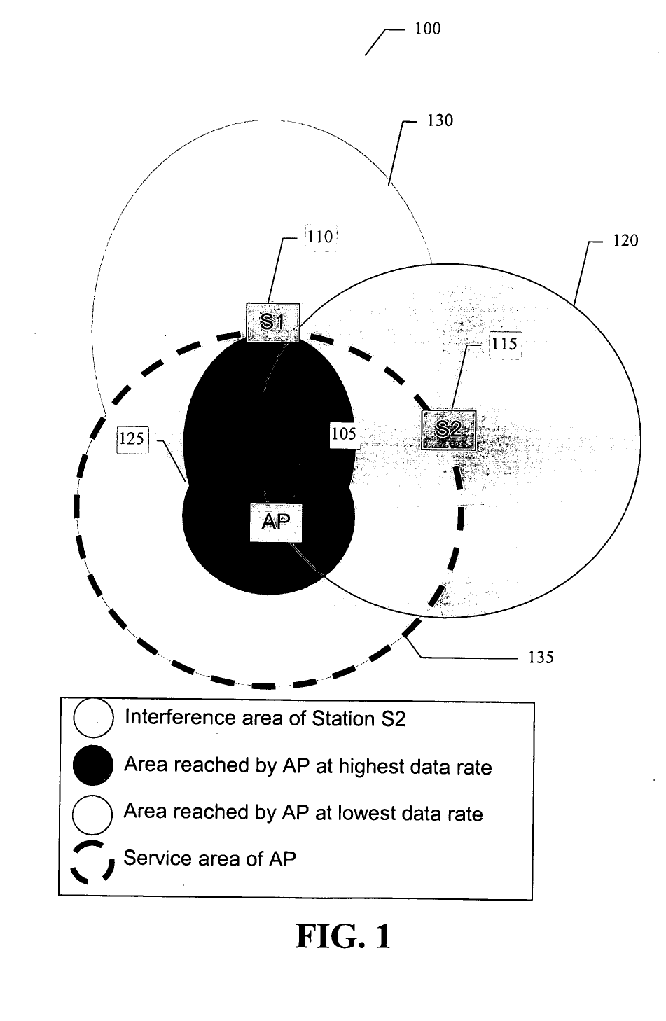

Turning now to FIG. 1, shown generally as 100, is a WLAN geometry of one embodiment of the present invention illustrating an access point (AP) 105 communicating with a Station S1 110 while keeping the NAV of a potentially interfering Station S2 115 updated. This FIG. 1 illustrates how the present invention mitigates the hidden node problem inherent to WLAN systems. The interference area of Station S2 is illustrated at 120 and the area reached by the AP at highest data rate is shown at 125 with the area reached by the AP at lowest data rate shown as the shaded region 130. The service area of the AP is shown by dashed line 135

Properties of the Medium Access Control (MAC) that are provided in one embodiment of the present invention may include that the MAC have all the properties of a standard IEEE 802.11 MAC with added functionality as described below. The MAC is assumed to be the master and the antenna system may be assumed to be a slave and all modes may be initiated and terminated by the MAC. Properties that may be included in the Adaptive Antenna System of one embodiment of the present invention are the WLAN PHY of this invention may have all the properties of a standard IEEE 802.11 PHY with an Adaptive Antenna functionality added as described below. The Antenna System may have a controller capable of managing all antenna hardware and the Antenna hardware may consist of passive tunable phase shifters and antenna elements—which may include voltage tunable dielectric material therein. An embodiment of the present invention may enable transceiver less components in the antenna system and as such may be incapable of monitoring any WLAN transmissions without inputs from the MAC; although the present invention is not limited in this respect.

Additional properties of the Antenna System may include that it is temperature compensated, i.e. the beam pattern will not drift over the operational temperature range, and the antenna system may have omni-directional and directional modes. Further, in the directional mode intended for IEEE 802.11b, the bore-sight antenna gain may not be more than 7 dB higher than in the omni mode, corresponding to the difference in WLAN receiver sensitivities for the 1 Mb/s, 11 Mb/s and greater data rates. The −7 dB beamwidth may be wider than 120 degrees and alternatively, the antenna gain in non-bore-sight directions may exceed the gain in omni mode. This measure mitigates the hidden node problem as shown in FIG. 1.

While the AP is directing its beam towards a particular station and communicating with it (at the highest rate), all other nodes within interfering range of the station would be able to receive the AP's preambles and headers (sent at the lowest data rate), update their NAV's and avoid collisions as shown in FIG. 1.

In the directional mode intended for 802.11a, the bore-sight antenna gain may not be more than 17 dB higher than in the omni mode, corresponding to the difference in WLAN receiver sensitivities for the 6 Mb/s and 54 Mb/s data rates—again, it is understood that the present invention is not limited to these data rates. The −17 dB beamwidth may be wider than 120 degrees. Alternatively, the antenna gain in non-bore-sight directions may exceed the gain in omni mode. In an embodiment of the present invention, the antenna system may settle to a new beam direction in less than 10 μs.

Considering modes of operation, the added MAC and PHY functionality may be applicable to present invention. One mode of operation may be the learning mode wherein it will enter a learning mode if it is determined that a whole new network is being configured or in case of an established network, a new STA or Access Point has been added. Learning is started by the MAC sending a command to the Antenna System containing the ID(s) of the new Station(s) or AP('s). Hardware inputs from MAC may include:

1. Received Signal Strength Indication (RSSI)—Analog,

2. Tx/Rx toggle—Boolean,

3. Clear Channel Assessment (CCA)—Boolean

During step 1 of the present invention, the MAC solicits pseudo transmissions from the new Station(s) or AP('s), e.g. by sending RTS commands and getting CTS signals in response. Alternatively, the system may wait for beacon signals from the new Station(s) or AP('s). At step 2 the antenna system finds the direction of arrival (DOA) for an incoming signal (CTS or beacon) that renders CCA negative. This would be done by first scanning over the entire sector allocated to the AP (could be 360 degrees) in full beamwidth steps, followed by two checks at half beamwidth around the peak RSSI. The exact DOA may be calculated through interpolation. A total of 5 to 8 steps taking about 60 to 90 μs should be sufficient to determine the DOA with enough accuracy, although the present invention is not limited to these times and numbers of steps. At step 3, when successful, the Antenna System sends a confirmation to the MAC. The criterion for success would be a clear peak in RSSI over antenna scan angle. Should the incoming signal terminate before a DOA fix could be established, the Antenna System may request the MAC to repeat the RTS/CTS sequence. Steps 1 to 3 could be repeated until a DOA fix is established or a time-out is reached. At step 4, after each successful DOA fix, the MAC may confirm the ID for the signal, or in case of a non-valid signal (such as interference), declare the signal as being invalid. The Antenna System may keep a log of signal ID's and associated DOA's, although it is not required to.

In the omni mode of operation in one embodiment of the present invention, first the decision to initiate Omni Mode is made. This may be the default mode for the system. Small data packets and short messages containing little or no data (such as RTS) should be sent while in omni mode. Also in case of larger data packets and favorable conditions allowing high data rates to be achieved, the system would remain in omni mode. To start, a MAC Command is given with no need for hardware inputs or actions from the MAC. The Antenna system may keep the antenna in omni or fixed sector mode. In fixed directional mode, the bit rate on a given link in a given direction may be set by the transmitter; in general each node will attempt to transmit to the other at the highest common bit rate, subject to the following constraints:

a. All Control frames are transmitted at one of the rates in the Basic Rate Set or at one of the rates in the PHY mandatory rate set so they will be understood by all Stations.

b. All multicast and broadcast frames are transmitted at one of the rates included in the Basic Rate Set.

c. 802.11b frame preambles and headers are transmitted using specific combinations of 1 Mb/s and 2 Mb/s, to ensure that the carrier sense mechanism of all other nodes in range is triggered, regardless of their capabilities.

d. Certain broadcast frames (e.g. beacons) must be sent at defined bit rates, so that all other nodes can decode them, regardless of their capabilities.

e. Certain management frames (e.g. RTS/CTS) must always be sent at the highest bit rate in the Basic Rate Set that is less than or equal to the bit rate used in the most recent data exchange between the nodes. This ensures that everyone in the BSS can hear the management traffic and thus know that the medium is busy and for how long it will remain so.

f. If one or more frames are not correctly received, a transmitter may reduce its bit rate in an attempt to improve link reliability. The precise algorithm for making this decision is implementation dependent, as is the algorithm for deciding to increase the bit rate. Again the choice of bit rates is constrained by the Operational Rate Sets of the two nodes.

It is understood that the above enumerated rules are merely exemplary and for illustrative purposes only. Numerous parameters and rules may be implemented and are intended to be within the scope of the present invention.

For the decision to initiate Fixed Directional Mode: Points a to e above should remain valid, while point f is rephrased as follows: When one or more frames are not correctly received, the AP reduces the data rate on short messages while remaining in omni mode. However, with regards to frames containing large data packets, the system attempts to use a directional antenna mode with the bit rate still at its highest level. Thereafter, should there still be an unacceptable frequency of incorrect frames; the transmitter would reduce the bit rate. However, if the system finds that the directional mode produced the same or worse results (as might happen when the node has physically moved or is moving), then the system needs to initiate a new Learning Mode for the particular node. This includes the MAC sending a command at least 10 μs before the anticipated start of the message. The MAC then provides the ID of the station with whom the directional communication is intended. The hardware inputs from MAC include a strobe (Boolean) indicating the instant at which the antenna should scan to the new direction associated with the ID. The Antenna System scans to the indicated direction and answers the strobe with an ACK.

An embodiment of the present invention further provides an adaptive Directional Mode which begins with a decision to initiate Adaptive Directional Mode wherein the same arguments apply as for the Fixed Directional Mode above. In addition, when the system determines that the node tends to move around often—as indicated by a frequent need for the Learning Mode—then the Adaptive Directional Mode is selected. This mode only applies while the station is being received. To start this mode, the MAC sends a command at least 10 μs before the anticipated start of the message. The MAC provides the ID of the station with whom the directional communication is intended. Strobes (Boolean) indicating the instant at which the antenna should scan to the new direction associated with the ID followed by a RSSI determination and transmission and reception and CCA.

The antenna system scans to the indicated direction and answers the strobe with an ACK. While the station is being received, the antenna system maintains optimal beam direction by dithering the beam direction and monitoring RSSI. The system also may update the log with the latest DOA.

In another embodiment of the present invention is provided a WLAN mesh network that may utilize the present invention. While the mesh is being formed, the system may remain in Omni Mode. Once the mesh has been established, the Learning Mode as described above may be invoked. Thereafter, the system is ready for Mesh operation. The Omni Mode may remain the default as with non-Mesh applications. For each physical link within the Mesh, the highest possible data rate is maintained by invoking the Fixed Directional Mode or Adaptive Directional Mode, when necessary.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. An apparatus, comprising:
a software controllable phased-array antenna with voltage tunable dielectric materials embodied therein enabling the concentration of RF energy from a transmitting wireless station (STA) into the direction of a receiving STA.

2. The apparatus of claim 1, further comprising controlling software embodied within a Medium Access Control layer (MAC) of a Wireless Local Area Network (WLAN) system with which said apparatus is a part of.

3. The apparatus of claim 2, wherein said controlling software controls the concentration of RF energy from a transmitting STA into the direction of a receiving STA, thereby allowing higher data rates and higher data throughput to be achieved by said WLAN system.

4. The apparatus of claim 2, wherein said antenna transmits sufficient RF energy in the direction of all other STAs in the service area in addition to said receiving STA, thereby preventing collisions by making them aware of ongoing transmissions.

5. The apparatus of claim 2, wherein said MAC is assumed to be the master and the phased-array antenna is assumed to be a slave.

6. The apparatus of claim 5, wherein all modes are initiated and terminated by said MAC.

7. The apparatus of claim 1, wherein said phased-array antenna has a controller capable of managing all antenna hardware.

8. The apparatus of claim 7, wherein said hardware comprises passive tunable phase shifters and antenna elements.

9. The apparatus of claim 1, wherein said phased-array antenna is temperature compensated so that a beam pattern will not drift over the operational temperature range.

10. The apparatus of claim 1, wherein said phased-array antenna has omni-directional and directional modes.

11. The apparatus of claim 10, said phased-array antennas is capable of settling to a new beam direction in less than 10 μs.

12. The apparatus of claim 11, wherein said apparatus is capable of operating in a learning mode, an omni mode, a fixed direction mode and/or an adaptive directional mode.

13. The apparatus of claim 1, wherein said apparatus is capable of operating in a Mesh network and the highest possible data rate is maintained by invoking the Fixed Directional Mode or Adaptive Directional Mode, when necessary.

14. A method of concentrating RF energy from a transmitting wireless station (STA) into the direction of a receiving STA in a wireless local area network (WLAN), comprising:
controlling a phased-array antenna by using voltage tunable dielectric materials embodied in said phase array antenna to concentrate said RF energy from said transmitting wireless station (STA) into the direction of said receiving STA in said wireless local area network (WLAN).

15. The method of claim 14, further comprising using software embodied within a Medium Access Control layer (MAC) of a Wireless Local Area Network (WLAN) system with which said apparatus is a part of to control said phased-array antenna.

16. The method of claim 15, wherein said controlling software controls the concentration of RF energy from a transmitting STA into the direction of a receiving STA, thereby allowing higher data rates and higher data throughput to be achieved by said WLAN system.

17. The method of claim 15, further comprising preventing collisions by making STAs aware of ongoing transmissions, by said antenna transmitting sufficient RF energy in the direction of all other STAs in the service area in addition to said receiving STA.

18. The method of claim 15, further comprising assuming said MAC is to be the master and assuming the phased-array antenna to be a slave.

19. The method of claim 18, further comprising initiating and terminating all modes by said MAC.

20. The method of claim 14, further comprising controlling said phased-array antenna by a controller capable of managing all antenna hardware.

21. The method of claim 20, wherein said hardware comprises passive tunable phase shifters and antenna elements.

22. The method of claim 14, further comprising using said phased-array antenna in omni-directional and directional modes.

23. The apparatus of claim 11, wherein said apparatus is capable of operating in a learning mode, an omni mode, a fixed direction mode and/or an adaptive directional mode.

24. The method of claim 14, further comprising operating in a Mesh network and maintaining the highest possible data rate by invoking the Fixed Directional Mode or Adaptive Directional Mode, when necessary.
